(19) United States
(12) Patent Application Publication
(10) Pub. No.: US 2004/0226653 A1
(43) Pub. Date: Nov. 18, 2004

(54) Adhesive setting apparatus and method of setting adhesive

(75) Inventors: Hirokazu Yamanishi, Kawasaki (JP); Tomokazu Sugiyama, Ashikaga (JP); Tsutomu Sooda, Kawasaki (JP); Yoshiaki Yanagida, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 10/873,687

(22) Filed: Jun. 22, 2004

Related U.S. Application Data
(63) Continuation of application No. PCT/JP01/11587, filed on Dec. 27, 2001.

(51) Int. Cl. C09J 5/00; B32B 31/26

(52) U.S. Cl. 156/305; 156/381; 156/497; 156/350; 156/307.7; 29/603.12

(57) ABSTRACT

A table receives an object, subjected to the adhesion process, in an adhesive setting apparatus. An adhesive have been applied on the object on the table. An exposure mechanism is designed to expose the adhesive to a gaseous accelerator. The adhesive setting apparatus utilizes the gaseous accelerator to promote the setting or hardening of the adhesive. The gaseous accelerator uniformly contacts the adhesive as compared with the mist of the accelerator. Since the adhesive is uniformly exposed to the gaseous accelerator, an uneven progression can reliably be avoided in the setting of the adhesive. It is possible to reliably avoid heterogeneity or localization of the set adhesive.

### BACKGROUND OF THE INVENTION

1. Field of the Invention

The present invention relates to a method of setting or curing an adhesive. In particular, the invention relates to such a method in which an accelerator is utilized to accelerate the setting of the adhesive.

2. Description of the Prior Art

An adhesive including a volatile constituent is well known. The volatile constituent in the adhesive constantly gets vaporized until the adhesive is completely set or cured. The vaporized volatile constituent often attaches to the object under the adhesion process at an area outside the area expected to receive the adhesive on the object. The volatile constituent pollutes the surface of the object in this manner.

It is preferable to reduce the time duration for setting the adhesive in order to prevent the pollution on the object. An accelerator is for example used to reduce the time duration for setting the adhesive. A liquid accelerator is sprayed on the adhesive applied on the object under the adhesion process. A spray nozzle is for example employed to spray the liquid accelerator.

However, the spraying makes the minute droplets of the liquid accelerator contact the adhesive. The setting of the adhesive is promoted over the area receiving the droplets, while the adhesive cannot enjoy the influence of the accelerator over an area between the adjacent droplets. The setting of the adhesive unevenly proceeds on the object. This induces heterogeneity or localization of the adhesive on the object. The adhesive cannot uniformly spread over the surface as expected.

### SUMMARY OF THE INVENTION

It is accordingly an object of the present invention to provide an adhesive setting apparatus capable of evenly and quickly setting an adhesive. It is an object of the present invention to provide a method of quickly and evenly setting an adhesive.

According to the present invention, there is provided an adhesive setting apparatus comprising: a table receiving an object, an adhesive being applied on the object on the table; and an exposure mechanism designed to expose the adhesive to a gaseous accelerator.

The adhesive setting apparatus utilizes the gaseous accelerator to promote the setting or hardening of the adhesive. The gaseous accelerator uniformly contacts the adhesive as compared with the mist of the accelerator, for example. Since the adhesive is uniformly exposed to the gaseous accelerator, an uneven progression can reliably be avoided in the setting of the adhesive. It is possible to reliably avoid heterogeneity or localization of the set adhesive.

For example, the exposure mechanism of the adhesive setting apparatus may comprise: an accelerator box containing the gaseous accelerator; and a doorway defined in the accelerator box, said doorway being opposed to the table. The doorway may comprise an opening opposed to the table, and a door designed to open and close the opening. The exposure mechanism is allowed to expose the adhesive to the gaseous accelerator obtained within the accelerator box in a facilitated manner.

Alternatively, the exposure mechanism of the adhesive setting apparatus may comprise: an accelerator box having a downward doorway, said downward doorway being opposed to the table; and a nozzle discharging a fluid accelerator toward a ceiling surface of the accelerator box from the downward doorway. The doorway may comprise an opening opposed to the table, and a door designed to open and close the opening. The fluid or liquid accelerator can be vaporized by being blown over the surface of a solid in a normal atmosphere. Specifically, if the fluid or liquid accelerator is sprayed over the ceiling surface of the accelerator box, a gaseous accelerator can in this manner be generated with in the accelerator box. The gaseous accelerator naturally leaks out of the downward doorway. The adhesive can be exposed to the leaked gaseous accelerator. Here, the accelerator may preferably include a volatile constituent. The volatile constituent promotes the vaporization of the accelerator.

The adhesive setting apparatus may further comprise a controller circuit designed to control the speed of opening and closing a door located in the doorway. The control of the speed of the door enables the control on the speed of the setting or hardening of the adhesive. Otherwise, the controller circuit may control the distance between the table and the opening of the doorway. The control of the distance likewise contributes to the control on the speed of the setting or hardening of the adhesive.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a partial sectional side view schematically illustrating the structure of an adhesive setting apparatus according to a specific example of the present invention;

FIG. 2 is a plan view schematically illustrating a door and an opening/closing mechanism;

FIG. 3 is a plan view schematically illustrating a working table and the concept of a table drive mechanism;

FIG. 4 is a plan view schematically illustrating a discharge nozzle and the concept of a nozzle drive mechanism;

FIG. 5 is a schematic view illustrating the air pressure system for the discharge nozzle;

FIG. 6 is a partial sectional side view schematically illustrating the structure of a pressurizing cylinder;

FIG. 7 is a block diagram schematically illustrating the control system for the adhesive setting apparatus;

FIG. 8 is a plan view of a jig for illustrating strips of a wafer adhered on the jig with an adhesive;

FIG. 9 is a partial side view of the adhesive setting apparatus for schematically illustrating an accelerator box and the discharge nozzle when the accelerator is sprayed;

FIG. 10 is a plan view of the jig for illustrating the position of the discharge nozzle spraying the accelerator; and

FIG. 11 is a partial sectional side view of the adhesive setting apparatus for schematically illustrating the strips of the wafer exposed to the gaseous accelerator on the jig on the working table.

### DESCRIPTION OF THE PREFERRED EMBODIMENT

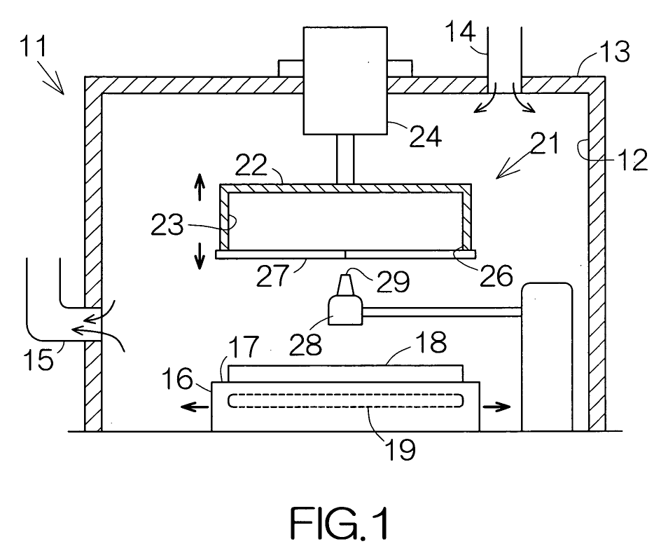

FIG. 1 illustrates an adhesive setting apparatus 11 according to a specific example of the present invention. The adhesive setting apparatus 11 includes a chamber box 13 defining a working chamber 12 on a base, a desk, a floor, or the like. An intake duct 14 and an exhaust duct 15 are connected to the chamber box 13. Air is introduced into the working chamber 12 from the intake duct 14 under a predetermined pressure. The introduced air thrusts the air out of the working chamber 12 from the exhaust duct 15. A sufficient ventilation can in this manner be established in the working chamber 12.

A working table 16 is located in the working chamber 12. The working table 16 is designed to receive an object 18, subjected to the adhesion process, on a horizontal receiving surface 17. An adhesive has been applied to the object 18 set on the working table 16. A cyano adhesive may be employed as the adhesive, for example. A heater 19 may be incorporated in the working table 16. The heater 19 serves to keep the adhesive on the object 18 at an optimal temperature level. The adhesive on the object 18 is designed to get set or cured fastest at the optimal temperature level. The working table 16 is allowed to move in a horizontal direction as described later in detail.

An exposure unit 21 is disposed within the working chamber 12. The exposure unit 21 includes an accelerator box 22 opposed at a distance to the receiving surface 17 of the working table 16. A vaporization chamber 23 is defined in the accelerator box 22. A pressurizing cylinder 24 is connected to the accelerator box 22. The pressurizing cylinder 24 is fixed to the ceiling of the working chamber 12. The accelerator box 22 is allowed to move in a vertical direction or in a direction perpendicular to the receiving surface 17 of the working table 16 with the assistance of the pressurizing cylinder 24 as described later in detail.

A downward opening 26 is formed in the accelerator box 22. The downward opening 26 is opposed to the receiving surface 17 of the working table 16. A door 27 is located in the opening 26. The door 27 may be constructed as a double door, for example. The door 27 serves to open and close the opening 26 as described later in detail. The door 27 may be supported on the accelerator box 22.

The exposure unit 21 further includes a discharge nozzle 28. The discharge nozzle 28 has an upward aperture 29. The discharge nozzle 28 is allowed to move in a horizontal direction as described later in detail.

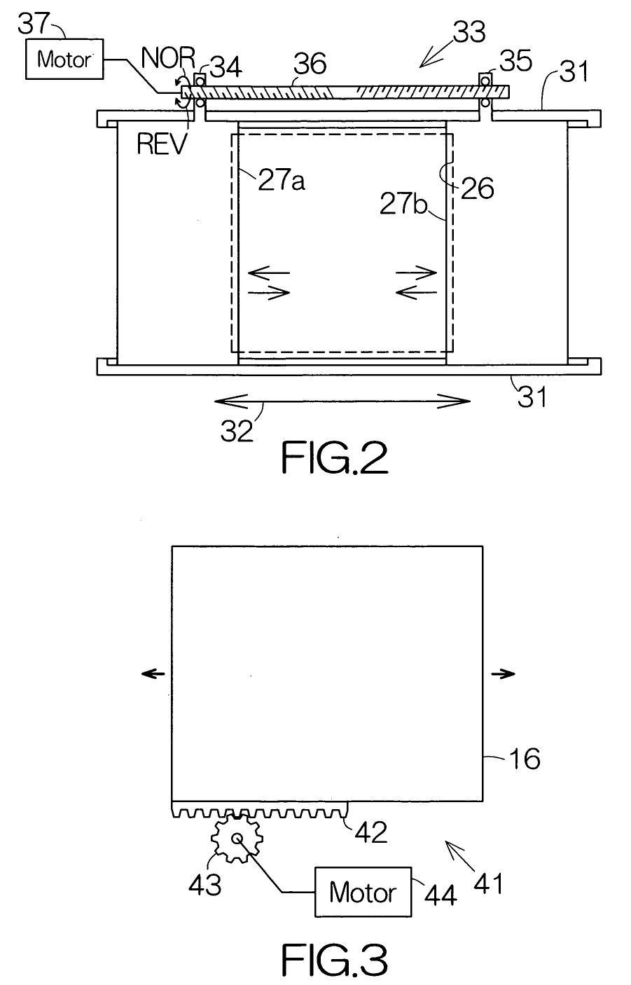

As shown in FIG. 2, the door 27 includes first and second door members 27a, 27b. The door members 27a, 27b are fitted between a pair of guide members 31, 31 extending in parallel with each other along a predetermined horizontal plane. The guide members 31, 31 may extend in the direction parallel to a straight datum line 32 defining the direction of opening and closing of the door 27. The guide members 31, 31 serve to guide the horizontal movement of the respective door members 27a, 27b.

An opening/closing mechanism 33 is connected to the door 27. The opening/closing mechanism 33 includes a first internal screw member 34 fixed to the first door member 27a and a second internal screw member 35 fixed to the second door member 27b. A common drives haft 36 is designed to engage the first and second internal screw members 34, 35. A thread is cut in a normal direction around the drive shaft 36 so as to engage the first internal screw member 34. A thread is likewise cut in the reverse direction, opposite to the normal direction, around the drive shaft 36 so as to engage the second internal screw member 35. When a power source such as an electric motor 37 drives the drive shaft 36 in the normal direction NOR, for example, the first and second door members 27a, 27b approach each other until the first and second door members 27a, 27b contact with each other. The opening 26 is thus completely closed. When the drive shaft 36 rotates in the reverse direction REV, the first and second door members 27a, 27b get distanced from each other. The opening 26 is opened up. As is apparent from FIG. 2, a so-called ball screw mechanism may be applied to the first and second internal screw members 34, 35 and the drive shaft 36. The other types of the door 27 and the opening/closing mechanism 33 can be employed to open and close the opening 26.

As shown in FIG. 3, a table drive mechanism 41 is connected to the working table 16. The table drive mechanism 41 includes a rack member 42 fixed to the working table 16, and a pinion member 43 designed to engage the rack member 42. An electric motor 44 serves to drive the pinion member 43 for rotation around its central axis, for example. When the pinion member 43 rotates, the working table 16 moves in a horizontal direction along the direction of the opening and closing of the door 27. The other types of a drive mechanism may be employed to realize the horizontal movement of the working table 16.

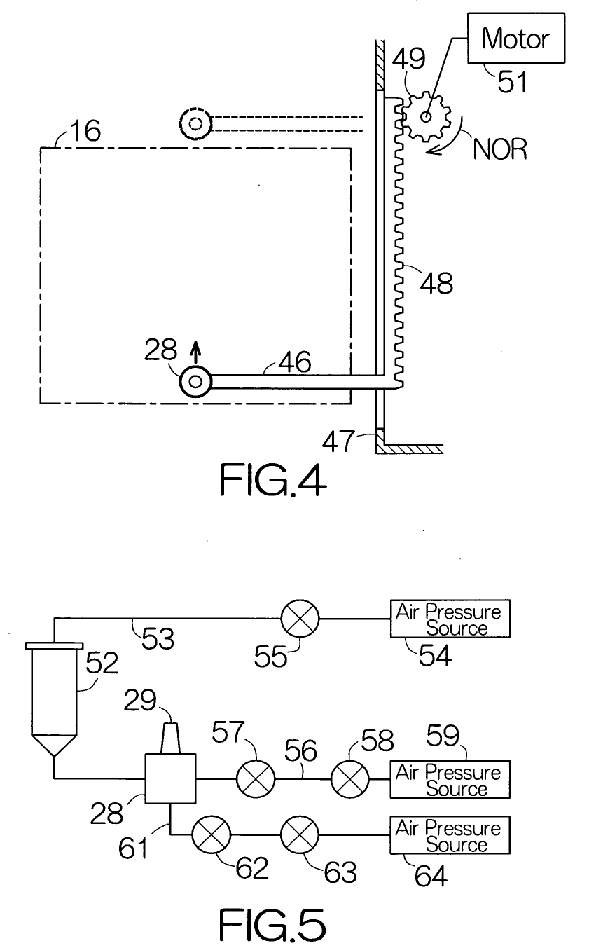

As shown in FIG. 4, a nozzle drive mechanism 45 is connected to the discharge nozzle 28. The nozzle drive mechanism 45 includes an arm member 46 extending in a horizontal direction from the discharge nozzle 28, and a guide frame 47 designed to guide the arm member 46 along a predetermined horizontal plane in the direction perpendicular to the straight datum line 32. A rack member 48 is fixed to the arm member 46. A pinion member 49 is designed to engage the rack member 48. The pinion member 49 is allowed to rotate around its vertical central axis. A drive source such as an electric motor 51 may be employed to realize the rotation of the pinion member 49. When the pinion member 49 rotates, the discharge nozzle 28 is caused to move in the horizontal direction in a direction perpendicular to the straight datum line 32. When the pinion member 49 rotates farthest in the normal direction NOR, for example, the discharge nozzle 28 can retreat out of a space defined between the receiving surface 17 of the working table 16 and the accelerator box 22.

As shown in FIG. 5, a syringe 52 is connected to the discharge nozzle 28. A fluid accelerator is filled within the syringe 52. Air under a predetermined pressure is supplied to the syringe 52 through a pressurizing channel 53, so that the fluid accelerator within the syringe 52 is supplied to the discharge nozzle 28. The pressurized air is introduced into the pressurizing channel 53 from an air pressure source 54. A pressure modulator valve 55 may be incorporated in the pressurizing channel 53 between the air pressure source 54 and the syringe 52 so as to adjust the pressure of the air.

A first air supply channel 56 is connected to the discharge nozzle 28. A switching valve, not shown, of the discharge nozzle 28 can be opened and closed in response to supply of air under a predetermined pressure from the first air supply channel 56. When the switching valve is opened, the fluid accelerator supplied from the syringe 52 is discharged from the upward aperture 29. A switching valve 57 may be incorporated in the first air supply channel 56 so as to allow and stop the supply of the air. Otherwise, a pressure modulator valve 58 may be incorporated in the first air supply channel 56, for example, so as to adjust the pressure of the supplied air. The pressurized air may be introduced into the first air supply channel 56 from an air pressure source 59.

A second air supply channel 61 is likewise connected to the discharge nozzle 28. The second air supply channel 61 serves to supply air under a predetermined pressure toward the upward aperture 29. The supplied air acts on the fluid accelerator discharged from the upward aperture 29. The supplied air serves to atomize the fluid accelerator. The atomized accelerator is thus discharged from the upward aperture 29. A switching valve 62 may be incorporated in the second air supply channel 61 so as to allow and stop the supply of the air. Otherwise, a pressure modulator valve 63 may be incorporated in the second air supply channel 61, for example, so as to adjust the pressure of the supplied air. The pressurized air may be introduced into the second air supply channel 61 from an air pressure source 64.

As shown in FIG. 6, the pressurizing cylinder 24 includes a cylinder body 66 defining an inner space for containing a piston 65 for vertical movement relative to the cylinder body 66. A first pressure chamber 67 is defined within the cylinder body 66 between the piston 65 and the upper end wall of the cylinder body 66. A second pressure chamber 68 is likewise defined within the cylinder body 66 between the piston 65 and the lower end wall of the cylinder body 66. A rod 69 is connected to the piston 65. The rod 69 airtightly penetrates through the cylinder body 66 at the second pressure chamber 68. The accelerator box 22 is coupled to the tip end of the rod 69. When pressure is introduced in the first pressure chamber 67, the piston 65 along with the accelerator box 22 moves downward. When pressure is introduced in the second pressure chamber 68, the piston 65 along with the accelerator box 22 moves upward. A switching valve 71 may be employed to switch over the supply of the pressure, for example. The switching valve 71 may supply the air pressure from an air pressure source to the first or second pressure chamber 67, 68, or stop the supply of the air pressure from the air pressure source.

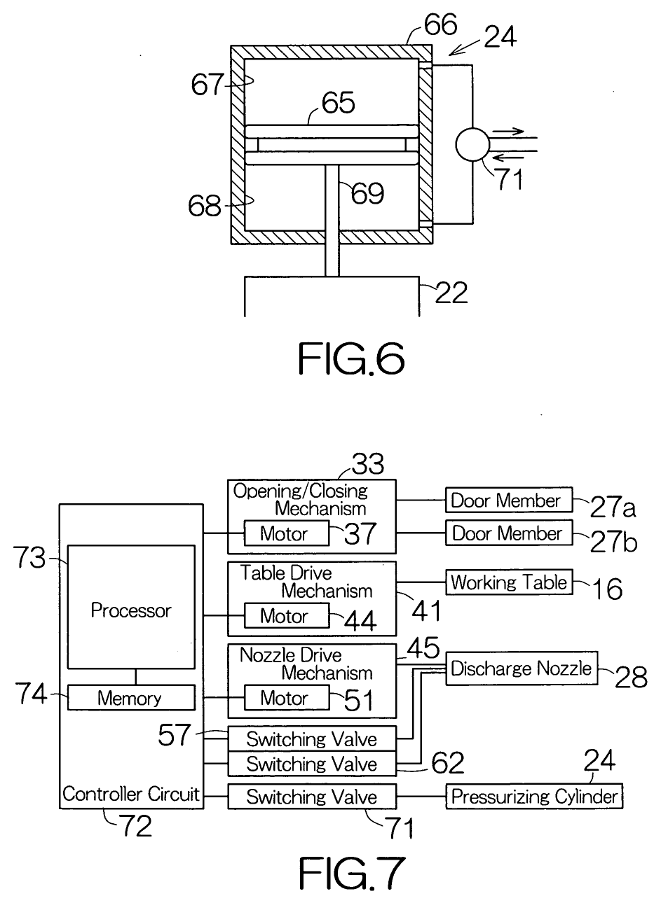

As shown in FIG. 7, a controller circuit 72 is attached to the adhesive setting apparatus 11. The controller circuit 72 is connected to the electric motor 37 of the opening/closing mechanism 33, the electric motor 44 of the table drive mechanism 41, the electric motor 51 of the nozzle drive mechanism 45, the switching valves 57, 62, 71, and the like. The controller circuit 72 supplies the electric motor 37 with instruction signals to open and close the door 27. The controller circuit 72 likewise supplies the electric motors 44, 51 with instruction signals to move the working table 16 and the discharge nozzle 28 in the horizontal directions. When the switching valves 57, 62 are opened and closed in accordance with instruction signals from the controller circuit 72, the accelerator can be discharged from the discharge nozzle 28 in response to the opening and closing of the switching valves 57, 62. When the switching valve 71 is switched over in accordance with instruction signals from the controller circuit 72, the accelerator box 22 can be positioned at a target location as a result of the upward and downward movement. The controller circuit 72 may comprise a processor 73 and a memory 74, for example. The processor 73 may execute software programs temporarily stored in the memory 74 so as to control the operation of the adhesive setting apparatus 11.

Now, assume that strips 76 of wafer are to be adhered on a jig 75 with an adhesive, as shown in FIG. 8, for example. The jig 75 includes an outer frame 78 fixed to the surface of a ceramic base plate 77. Two application areas are defined inside the outer frame 78. The application areas independently extend along parallel straight reference lines 79a, 79b. The application area may be formed in a rectangle having a length L=100 mm and a width W=50 mm, for example.

The strips 76 of the wafer are arranged in a row within the individual applications area. The centers of the strips 76 in the longitudinal directions are aligned on the corresponding straight reference lines 79a, 79b. An interval d is set at 80 μm approximately between the adjacent strips 76 in the individual row, for example. Specifically, the elongated spacing having the width of 80 μm is defined between the adjacent strips 76 of the wafer.

The strips 76 of the wafer are cut out from a disk-shaped wafer, for example. Magnetic head elements are mounted in a row on the individual strip 76 of the wafer. A head slider is cut out from the strip 76 for the individual magnetic head element. The head slider will be assembled into a hard disk drive (HDD), for example.

A fluid adhesive is poured over the surface of the base plate 77. The adhesive may be dropped at the opposite ends of the elongated spacings between the adjacent strips 76. The capillary attraction forces the fluid adhesive to flow into the elongated spacings. The strips 76 are covered with the adhesive all over the surface facing the elongated spacings. When the adhesive have been cured or hardened, air bearing surfaces are then shaped at the upper surfaces of the strips 76. The upper surfaces of the strips 76 of the wafer are subjected to ion milling, etching, abrading, and the like, on the jig 75. In this case, the cured or hardened adhesive serves to reliably protect the magnetic head elements at the side surfaces of the strips 76 of the wafer.

The aforementioned adhesive setting apparatus 11 is utilized to accelerate the curing or hardening treatment of the adhesive. The jig 75 is set on the working table 16 in the adhesive setting apparatus 11. As is apparent from FIG. 8, the straight reference lines 79a, 79b of the jig 75 are aligned to intersect the straight datum line 32 at right angles on the receiving surface 17. The accelerator box 22 is then positioned relative to the jig 75 on the receiving surface 17. The table drive mechanism 41 is allowed to move the working table 16 in the horizontal direction so as to position the accelerator box 22. In this case, the contacting line of the first and second door members 27a, 27b is aligned on the straight reference line 79a. The first and second door members 27a, 27b are designed to contact each other at the contacting line to completely close the opening 26.

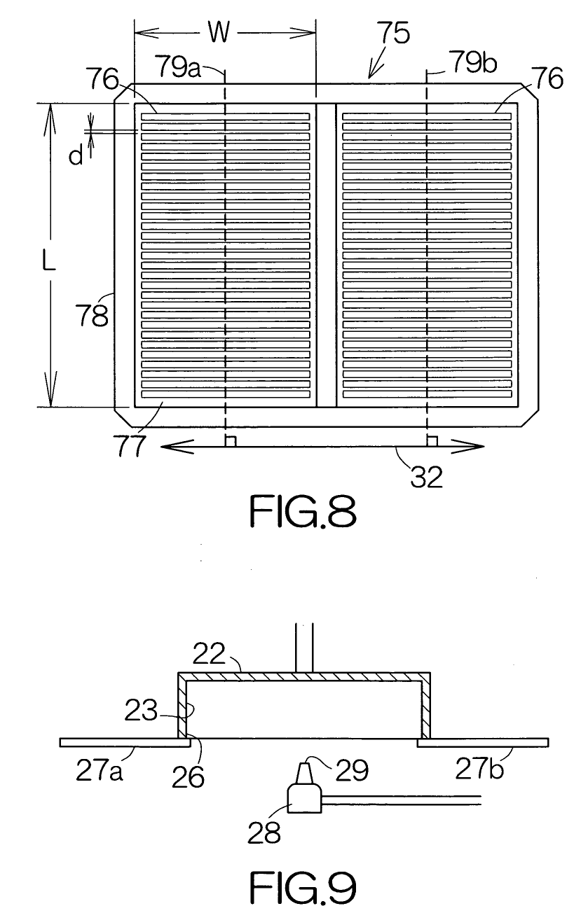

Thereafter, the nozzle drive mechanism 45 operates to position the discharge nozzle 28 right below the box in accordance with the instructions from the controller circuit 72. The upward aperture 29 of the discharge nozzle 28 is opposed to the contacting line between the first and second door members 27a, 27b. The opening/closing mechanism 33 then operates to open the door 27 in accordance with the instructions from the controller circuit 72, as shown in FIG. 9. The opening/closing mechanism 33 has the first and second door members 27a, 27b distanced furthest from each other. The upward aperture 29 of the discharge nozzle 28 is in this manner opposed to the opening 26 of the accelerator box 22.

The nozzle drive mechanism 45 then operates to move the upward aperture 29 of the discharge nozzle 28 in the horizontal direction along the straight reference line 79a in accordance with the instructions from the controller circuit 72. The fluid accelerator is sprayed against the inner surface of the accelerator box 22, namely the ceiling surface of the vaporization chamber 23, from the discharge nozzle 28 during such a horizontal movement. The switching valves 57, 62 are simultaneously opened in accordance with the instructions from the controller circuit 72. The sprayed accelerator sticks to the ceiling of the vaporization chamber 23. After the discharge nozzle 28 has sprayed a sufficient amount of the accelerator, the discharge nozzle 28 is allowed to retreat from a space defined between the accelerator box 22 and the working table 16.

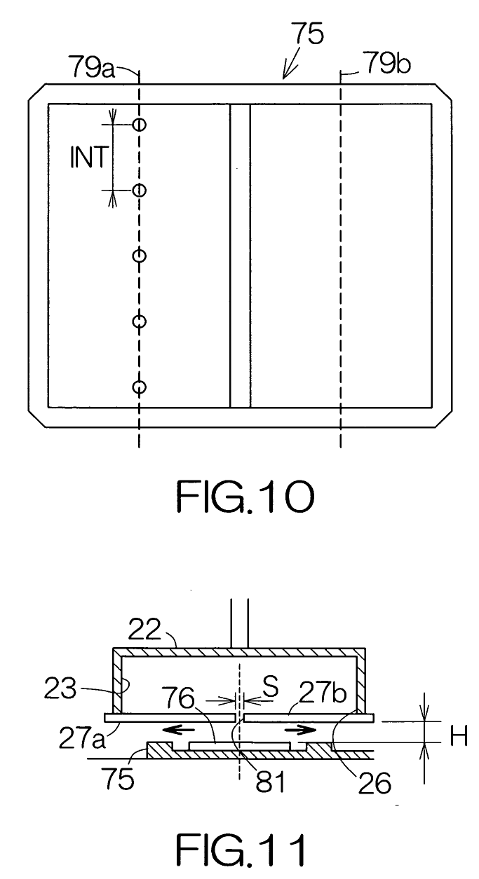

As is apparent from FIG. 10, the accelerator may be sprayed five times, for example, at constant intervals, INT=20 mm, for example. The accelerator is in this manner uniformly applied to the ceiling of the vaporization chamber 23 along the straight reference line 79a. Otherwise, the accelerator may continuously be applied to the ceiling of the vaporization chamber 23 during the horizontal movement of the discharge nozzle 28.

As shown in FIG. 11, when the spraying is completed, the opening/closing mechanism 33 operates to form a slit 81 between the first and second door members 27a, 27b in accordance with the instructions from the opening/closing mechanism 33. The width S of the slit 81 may be set at 10 mm approximately, for example. The fluid accelerator sticking to the ceiling of the vaporization chamber 23 gradually gets vaporized. The vaporization chamber 23 is getting full of the accelerator of a gaseous status in this manner.

Thereafter, the accelerator box 22 is positioned at a predetermined height H from the upward surface of the strips 76 of the wafer. The pressurizing cylinder 24 operates to move the accelerator box 22 in upward and downward directions in accordance with the instructions from the controller circuit 72. Here, the height His set at 3 mm approximately. The gaseous accelerator in the vaporization chamber 23 is allowed to leak from the slit 81. The gaseous accelerator falls over the adhesive on the jig 75. When the gaseous accelerator contacts the adhesive, the setting of the adhesive is accelerated. The working table 16 may be maintained at the optimal temperature level, approximately equal to 40 degrees Celsius, with the assistance of the heater 19.

Subsequently, the first and second door members 27a, 27b are allowed to gradually get distanced from each other. The opening degree of the door 27, namely the width S of the slit 81, accordingly gets larger. The first and second door members 27a, 27b may move at a constant speed, for example. Here, it takes approximately 80 seconds to completely open the opening 26. The gradual opening of the opening 26 allows the adhesive to get exposed to the gaseous accelerator in the elongated spacings between the strips 76 gradually from the center to the outer ends in the longitudinal direction. If the promotion of the setting of the adhesive starts in this manner from the center of the longitudinal direction, the adhesive reliably remains to completely fill the elongated spacings between the strips 76. To the contrary, if the setting of the adhesive starts from the outer ends of the elongated spacings, the shrinkage of the set adhesive at the outer ends induces reduction in the amount of the adhesive at the center in the longitudinal direction. In this case, the surface of the strips 76 may partly get exposed. After the opening 26 has completely opened, the opening of the opening 26 will be kept in 20 seconds approximately, for example.

The gaseous accelerator uniformly contacts the adhesive. Since the adhesive is uniformly exposed to the gaseous accelerator, an uneven progression can reliably be avoided in the setting of the adhesive. The adhesive is allowed to keep an even and constant spread on the base plate 77. It is possible to reliably avoid heterogeneity or localization of the set adhesive.

When the supply of the accelerator has been completed along the straight reference line 79a, the door 27 is closed. The accelerator box 22 is then temporarily lifted. The accelerator box 22 is distanced from the receiving surface 17 of the working table 16. The accelerator box 22 is subsequently positioned relative to the jig 75 on the receiving surface 17 again. Here, the contacting line of the first and second door members 27a, 27b is aligned right on the straight reference line 79b. The gaseous accelerator is thereafter applied to the adhesive on the jig 75 in the same manner as described above. The adhesive has in the aforementioned manner gotten cured or hardened on the jig 75.

It is possible to control the speed of setting an adhesive in the adhesive setting apparatus 11, for example, by adjusting the height H and/or the position of the opening 26 relative to the adhesive on the working table 16. It is possible to control the amount of the gaseous accelerator falling over an adhesive in the adhesive setting apparatus 11, for example, by adjusting the amount of the fluid accelerator sprayed over the inner surface of the vaporization chamber 23. Additionally, it is also possible to control the speed of setting an adhesive in the adhesive setting apparatus 11, for example, by adjusting the speed of opening and closing of the door 27. The setting of these control parameters may depend on the kinds of the adhesive. The setting of those control parameters may depend on the kinds of the accelerator. The selection of an accelerator may depend on the kind of the adhesive.

What is claimed is:

1. An adhesive setting apparatus comprising:
a table receiving an object, an adhesive being applied on the object on the table; and
an exposure mechanism designed to expose the adhesive to a gaseous accelerator.

2. The adhesive setting apparatus according to claim 1, wherein said exposure mechanism comprising:
an accelerator box containing the gaseous accelerator; and
a doorway defined in the accelerator box, said doorway being opposed to the table.

3. The adhesive setting apparatus according to claim 1, wherein said exposure mechanism comprising:
an accelerator box having a downward door way, said downward doorway being opposed to the table; and
a nozzle discharging a fluid accelerator toward a ceiling surface of the accelerator box from the downward doorway.

4. The adhesive setting apparatus according to claim 3, wherein said accelerator includes a volatile constituent.

5. The adhesive setting apparatus according to claim 3, further comprising a controller circuit designed to control speed of opening and closing a door located in the doorway.

6. The adhesive setting apparatus according to claim 5, wherein said accelerator includes a volatile constituent.

7. The adhesive setting apparatus according to claim 5, wherein said controller circuit controls a distance between the table and the doorway.

8. The adhesive setting apparatus according to claim 7, wherein said accelerator includes a volatile constituent.

9. A method of setting an adhesive, comprising exposing the adhesive to a gaseous accelerator.

10. A head slider produced by utilizing the method according to claim 9.

11. The method according to claim 9, further comprising blowing a fluid accelerator against a surface of a solid so as to vaporize the accelerator.

12. A head slider produced by utilizing the method according to claim 11.

13. The method according to claim 11, wherein said accelerator includes a volatile constituent.

14. A head slider produced by utilizing the method according to claim 13.
